(19) United States
(12) Patent Application Publication
(10) Pub. No.: US 2012/0208725 A1
(43) Pub. Date: Aug. 16, 2012

(54) Drilling Fluid Additive and Method for Improving Lubricity or Increasing Rate of Penetration in a Drilling Operation

(75) Inventor: Terry W. Hoskins, Calgary (CA)

(73) Assignee: CANADIAN ENERGY SERVICES, L.P., Calgary (CA)

(21) Appl. No.: 13/453,599

(22) Filed: Apr. 23, 2012

Related U.S. Application Data
(63) Continuation of application No. 12/666,212, filed on Dec. 22, 2009.
(60) Provisional application No. 60/929,346, filed on Jun. 22, 2007.

(30) Foreign Application Priority Data
Aug. 27, 2007 (CA) 2,599,085

(51) Int. Cl. C09K 8/06; C09K 8/34; C09K 8/035

(52) U.S. Cl. 507/138

(57) ABSTRACT

The present invention relates to a drilling fluid additive for improving lubricity or rate of penetration (ROP) in a drilling operation, such as an oil and gas drilling operation. The additive comprises particles of wax or waxy substance, or a mixture of two or more types of the particles having distinct properties, such as particle size, type of wax or waxy substance, melt point, solubility, dissolution rate, hardness, shape, blocking ability, or a combination thereof. In certain embodiments, the additive is environmentally friendly and biodegradable. The invention also relates to a drilling fluid comprising the drilling fluid additive of the invention. A method of improving lubricity or increasing ROP in a drilling operation is also provided, as well as a use of particles of wax or waxy substance or mixture thereof as a drilling fluid additive for improving lubricity or increasing ROP in a drilling operation.

### CROSS-REFERENCE TO RELATED APPLICATIONS

This application represents a continuation application of U.S. patent application Ser. No. 12/666,212 filed Dec. 22, 2009 which represents a National Stage application of PCT/CA2008/001130 entitled “Drilling Fluid Additive and Method for Improving Lubricity or Increasing Rate of Penetration in as Drilling Operation' filed Jun. 13, 2008, pending, which claims the benefit of U.S. Provisional Patent Application Ser. No. 60/929,346, filed Jun. 22, 2007.

### FIELD OF THE INVENTION

The present invention relates generally to drilling operations. More particularly, the present invention relates to a drilling fluid additive and method for improving lubricity or increasing rate of penetration in a drilling operation.

### BACKGROUND OF THE INVENTION

In the process of drilling a well into an oil and gas bearing formation, a drilling fluid or “mud” is pumped into the developing well bore through the drill pipe and exits through nozzles in the rotating drill bit mounted at the end of the drill pipe. The drilling fluid is then circulated back to the surface through the annulus, the space between the drill pipe and the wall of the well bore. Back at the surface, solids are removed and the mud is pumped to a fluid tank where it can be reused or treated if necessary. The drilling fluid system is typically designed as a loop with the drilling fluid continually circulating as the drill bit rotates. Drilling fluid performs several functions essential to the successful completion of an oil or gas well and enhances the overall efficiency of the drilling operation. Drilling fluid is used, for instance, to cool and lubricate the rotating drilling tool, to reduce friction between the bit and the well bore, to prevent sticking of the drill pipe, to control subsurface pressure in the well bore, to lift the drill cuttings and carry them to the surface, and to clean the well bore and drilling tool.

The major component of drilling fluid is its base fluid. A drilling fluid may be aqueous based, hydrocarbon based, synthetic based, or an emulsion, such as an oil-in-water or water-in-oil (“invert”) emulsion. Aqueous based, or water based, drilling fluids are used frequently in the industry. They provide an economic advantage over oil based drilling fluids and are also more environmentally friendly. However, for certain formations, drilling with aqueous based fluids can be problematic due to well bore instability caused by the swelling of water-absorbing rock and clay in the formation, hydration of which can be greatly reduced by using an oil based drilling fluid. Although oil based fluids are more costly than aqueous based fluids, they are generally preferred for deep drilling, high temperature drilling or when a substantially non-reactive base fluid is required for a particular drilling operation or formation. While oil based fluids tend to provide more natural lubrication than water based fluids and achieve greater increases in drilling progress, or increased rates of penetration (ROP), drilling operators still encounter areas of undesirable torque and drag in a hydrocarbon environment, as well as other problems such as pipe sticking.

To improve lubricity and enhance ROP during drilling, lubricating additives are added to: the drilling fluid system to overcome friction and decrease torque and drag. The available lubricants have not proven entirely effective and suffer various disadvantages. The available additives are often environmentally unfriendly and also very costly. Lubricating additives fall into two general categories: solid lubricants and liquid lubricants.

Solids can permanently damage an oil or gas bearing formation and hinder production. Solids can also interfere with drilling equipment and complicate solids control procedures. Exemplary solids that have been added to drilling fluid systems in attempt to improve lubricity include, graphite, bentonite clays, uintaite (e.g., Gilsonite™), cellulosic materials and even plastic and glass beads. Glass beads and polymer beads provide a ball bearing type of lubricating effect and embed themselves in the surface of the filter cake to decrease points of contact between the equipment and the bore hole wall. Glass and polymer beads tend to interfere with solids control and are highly damaging if they become embedded in the formation since they do not degrade and cannot be easily removed. Many operators therefore avoid drilling with such products. Graphite acts as a lubricant in areas of metal to metal contact by forming thin layers that are sheared between the metal surfaces to decrease friction.

Liquid lubricants provide only temporary relief from torque and drag. They are difficult to keep in place where needed and most tend to microemulsify downhole over time, rendering them ineffective. Liquid lubricants can also negatively impact the physical and chemical properties of the drilling fluid, such as yield point, surface tension and density, Which must be tightly controlled. Foaming is another disadvantage associated with known liquid lubricants. To counteract foaming, costly defoamers must be added to the system. Liquids can also permanently damage the formation being drilled. Exemplary liquids that have been added to drilling fluids to improve lubricity during drilling include diesel oil, vegetable oil, detergents, alcohols, glycerins and amines. U.S. Pat. No. 4,876,017 discloses a synthetic hydrocarbon compound, specifically a polyalphalolefin, which may be combined with emulsifiers and thinners as a downhole lubricant in an offshore drilling operation. U.S. Pat. No. 5,045,219 is exclusively directed to a liquid polyalphaolefin lubricant composition for use in offshore drilling.

A further disadvantage associated with available lubricants is that their presence in the drilling fluid can cause the fluid to fail microtoxicity testing and render the fluid ineligible for full disposal. In addition to the environmental benefits, a drilling fluid that is fully disposable is highly desirable since treatment and alternative disposal of drilling waste adds to the overall cost of a drilling operation.

It is therefore desirable to provide improved drilling fluid additives for improving lubricity in a drilling operation. It is furthermore desirable to provide improved drilling fluid additives for increasing rates of penetration in a drilling operation. Improved additives that are practical, environmentally friendly, and economical in manufacture and use, are considered particularly desirable.

### SUMMARY OF THE INVENTION

It is an object of the present invention to obviate or mitigate at least one disadvantage associated with previous drilling fluid additives for improving lubricity or increasing rate of penetration in a drilling operation.

In a first aspect, the present invention provides a drilling fluid additive for improving lubricity or rate of penetration in a drilling operation. The additive comprises particles of wax or waxy substance; or a mixture of two or more type of said particles having at least one property distinct from one another.

Where the additive comprises a mixture of particles having at least one distinct property, the at least one distinct property may include particle size, type of wax or waxy substance, melt point, solubility, dissolution rate, hardness, shape, blocking ability, or a combination thereof.

It is preferred that the particles remain substantially solid at ambient temperature for ease of handling and storage. By substantially solid, it is meant that the particles will not permanently block together or melt at ambient temperature.

In certain embodiments, the wax or waxy substance is a natural wax or a synthetic wax.

In certain embodiments, all or a portion of the particles become softened, smeared, temporarily liquefied, liquefied or a combination thereof upon exposure to mechanical forces or temperatures encountered during the drilling operation.

In certain embodiments, the wax or waxy substance is selected such that all or a portion of the particles are substantially insoluble in a selected base fluid, carrier fluid or drilling fluid at temperatures below the melt point of the particles. In such embodiments, the particles will remain substantially solid in the selected fluid at temperatures below melt point.

The particles in the additive may be microparticles, macroparticles or a mixture thereof. As used herein, microparticles refer to particles having a general sizing smaller than about 50 microns and macroparticles refer to particles having a general sizing larger than about 50 microns.

In certain embodiments, the drilling fluid additive is environmentally friendly and biodegradable. In certain embodiments, the drilling fluid additive meets the strict standards for offshore drilling operations.

The additive is suitable for use in drilling fluids, well kill fluids or other well treatment fluids. In certain embodiments, the fluid is a drilling fluid.

In a further aspect, the present invention provides a drilling fluid comprising a drilling fluid additive of the invention. The drilling fluid may be hydrocarbon based, aqueous based, synthetic based or an emulsion.

In one embodiment, the drilling fluid is aqueous based and meets the requirements for full disposable upon completion of the drilling operation.

In another aspect, the present invention provides a method of improving lubricity or rate of penetration (ROP) in a drilling operation. The method comprises providing a drilling fluid comprising a drilling fluid additive of the present invention, and pumping the drilling fluid downhole during the drilling operation.

In another aspect, there is provided a method of lubricating a drilling tool or improving drill bit performance during a drilling operation comprising, providing a drilling fluid comprising a drilling fluid additive of the invention, and pumping the drilling fluid downhole during a drilling operation.

In another aspect, there is provided a drilling fluid additive for enhancing lubricity or rate of penetration (ROP) in a process of drilling an oil or gas well. The additive comprises particles of wax or waxy substance or mixture thereof, all or a portion of the particles have a melt point below a geothermal temperature in an underground formation or at a production zone of the formation such that all or a portion of the particles will melt upon completion of the drilling process for ease of removal from the formation.

In another aspect, there is provided a non-damaging drilling fluid additive for enhancing lubricity or rate of penetration (ROP) in a process of drilling an oil or gas well into a subterranean formation, the additive consisting essentially of particles of wax or waxy substance or a mixture of said particles having distinct properties, the particles remain substantially solid at ambient temperature for storage and handling, and wherein all or a portion of the particles have a melt point below a geothermal temperature at a production zone of the formation to promote geothermal removal of residual additive from the formation after completion of the drilling process.

In another aspect, there is provided a use of particles of wax or waxy substance or mixture of said particles having distinct properties as a drilling fluid additive for increasing lubricity or rate of penetration (ROP) in a drilling operation.

In another aspect, there is provided a drilling fluid additive for use as a lubricant or rate of penetration (ROP) enhancer in a drilling operation, the additive consisting essentially of particles of wax or mixture thereof having distinct properties, the particles having a melt point above about 60° C. and a hardness value less than about 20 dmm at 25° C.

The drilling fluid additives of the present invention improve lubricity or increase rate of penetration (ROP) in a drilling operation compared to the same operation without the additive.

Other aspects and features of the present invention will become apparent to those ordinarily skilled in the art upon review of the following description of specific embodiments of the invention described below.

### DETAILED DESCRIPTION

Generally, the present invention provides a drilling fluid additive and method for improving lubricity or increasing rate of penetration (ROP) in a drilling operation, such as an oil or gas drilling operation. A drilling fluid comprising the drilling fluid additive is also provided, as well as a use of the drilling fluid additive in a base fluid or drilling fluid to improve lubricity or increase ROP in a drilling operation.

Canadian Patent Application No. 2,583,484 to the present inventor discloses drilling fluid additives for reducing or controlling lost circulation to a porous underground formation in the process of drilling a well. The additives comprise solid wax or waxy particles that are substantially insoluble in hydrocarbons below their melt point. It has now surprisingly been demonstrated that effective drilling fluid additives comprising solid wax or waxy particles are effective for improving lubricity in a drilling operation. Surprisingly, it has also been demonstrated that the presence of such particles in a drilling fluid system can increase ROP in a drilling operation, which is not predictable based the demonstrated lubricant effects alone. Increases in ROP lead to decreased time and cost of a drilling operation.

Although liquid hydrocarbons have previously been used as lubricants and ROP enhancers in drilling operations, subject to the disadvantages of liquid lubricants mentioned above, the use of solid wax or waxy particles for improving lubricity or increasing ROP in a drilling operation has not previously been reported.

Traditional lubricants are generally either solids, providing a ball-bearing or shearing type of lubricant effect, or liquids. In contrast to these traditional lubricants, waxes and waxy substances can take the form of a solid, semi-solid or liquid, depending on their physical or chemical characteristics and the conditions to which they are exposed, and are generally somewhat malleable. Solid wax or waxy particles are generally thought of as being tacky and are not therefore obvious candidates for use as lubricants in a drilling operation. Furthermore, waxes are thought to be susceptible to solubility and temperature issues, and difficult to control or disperse in a fluid. It would not therefore be apparent that a wax particle could function as either a traditional solid or liquid lubricant in a drilling fluid system or that a wax particle could provide a predictable or consistent lubricant effect given the various conditions to which the particle would be exposed during a drilling operation, including temperatures and pressures that could alter the particles. Moreover, the presence of wax in a drilling system is generally considered undesirable in the industry and is often avoided. For at least these reasons, it would not be apparent to use solid wax or waxy particles as a drilling fluid additive for improving lubricity or increasing rate of penetration in a drilling operation.

The drilling fluid additives of the present invention exert a unique property in that they possess the ability to change form depending on the conditions or elements to which they are exposed. In a typical drilling operation, the additives are exposed to high mechanical and shearing forces that can alter the shape of the particles. The particles are also exposed to various temperatures and the physical state of the particles can be controlled by selecting materials that have a specific melt point or solubility in a given drilling fluid. It is believed that this unique ability to change shape and state contributes, in part, to the effectiveness of the additive as a lubricant and an ROP enhancer, as well as the blocking properties of the particles. The particles can become smeared or layered onto the drilling equipment or wellbore wall to provide a lubricant effect. The particles can also become smeared onto or embedded in any filter cake that is formed and can alter the properties of the filter cake. As increasing amounts of the wax or waxy substance become adhered onto or embedded into the filter cake, the filter cake becomes more lubrous and the coefficient of friction may be reduced.

As an added benefit, the presence of the additive in the filter cake can enhance filter cake stability, in part due to the blocking ability of the wax or waxy substance, and can transform the filter cake into a hydrophobic barrier to inhibit hydration of shales or clays when drilling with an aqueous drilling fluid. The presence of wax or waxy material in the filter cake also increases the ability of the filter cake to adhere to the wellbore wall even if differential pressures are reversed during the operation. The drilling fluid additives of the present invention may reinforce hole stability in some cases, via the malleable insertion of additive into the formation due to mechanical forces or pressure differentials between the well bore fluid and the underground formation.

Where areas of high temperature are encountered downhole, such as at the location of the rotating drill bit and cutters against the developing wellbore, the additives can be exposed to temperatures that result in melting of all or a portion of the particles in the area of high temperature. In an aqueous environment, liquefied wax or waxy material advantageously provides an environmentally friendly way to change the wet state of the cutters from water-wet to oil-wet, to keep the cutters clean and lubricated and free from water Wet solids, and thereby reduce the phenomenon of bit balling. When bit balling occurs, the bit must be hauled out of the hole and cleaned or replaced, thereby resulting in downtime in the operation. This effect of lubricating the drill bit and altering the wettability of the cutters can extend the operational life of the drilling bit by many hours and also reduce downtime in the operation. A similar lubricating effect may also occur along the rotating drill pipe and may contribute to the reduction in pipe sticking. Liquefied wax or waxy material exhibits an affinity for metal and tends to cool and resolidify on proximal metal surfaces, such as the drill bit and cutters, thereby providing a solid-liquid-solid lubricant effect that can provide a lubricating coating on the drilling tool components. Liquefied wax that leaves the hot spot will cool in the drilling fluid on the way back up to surface and can adhere to drill solids in the drilling fluid or reform small granules that can be recirculated or removed from the fluid.

The drilling fluid additives of the present invention can provide effective pinch point lubrication in a drilling operation as well. Pinch point lubrication is important in any drilling operation and is especially important when drilling deviated or horizontal wells. Pinch point lubrication refers to the placement of a lubricant into or near a point of adverse or undesired torque and drag, friction build up, or resistance to motion of the drill pipe or drill string components in the drilling operation. The drilling fluid additive can be added to the fluid and pumped to the pinch point as a portion of the drilling fluid or in pill form where the particles move into place between the pinch points and, under the pressures and temperatures created, may be smeared, smeared and liquefied, or liquefied to provide lubrication at that pinch point.

Using particles of wax or waxy substance as a pinch point lubricant in a hydrocarbon drilling fluid may provide a solid-liquid-solid lubricant effect as described above, or a solid-liquid lubricant effect if a wax is selected that will go into solution with the base oil. When a pure liquid lubricant is added to a hydrocarbon drilling fluid, it becomes dispersed into the fluid well before getting to the point where it is needed and therefore its effectiveness is reduced. However, with the drilling fluid additives of the present invention, the wax or waxy material may be selected such that it will remain substantially solid until it gets to the pinch point, where it will then dissolve or become temporarily liquefied to provide a liquid lubricant effect right at the pinch point. The physical state of the additive downhole can be influenced by selecting waxes or waxy substances having a desired melt point, hardness or dissolution rate in a given drilling fluid. Where it is preferred that the particles remain in a substantially solid state, for instance, a high melt point material that is substantially insoluble in the drilling fluid can be selected.

The additive may be mixed with or added to a drilling fluid, a base fluid, or a carrier fluid. The drilling fluid into which the additive is dispersed may be aqueous based, oil based, synthetic based or an emulsion. The emulsion may be a water-in-oil or an oil-in water (“invert”) emulsion. The drilling fluid may also be a well kill fluid, which is a drilling fluid with a density great enough to produce a hydrostatic pressure to substantially shut off flow into a well from an underground formation. While the emphasis is placed on drilling fluids, the additive may be added to other well treatment fluids in any process where improved lubricity is desired. The drilling fluid additive may be added to a fluid prior to drilling, for example in mixing tanks, or while drilling ahead, or may be spotted downhole in pill form during drilling, or a combination of the above.

It was previously thought that wax particles could not be effectively dispersed in a drilling fluid, particularly an aqueous based fluid, without the use of dispersants, surfactants, stabilizers, emulsifiers or the like. Such agents can negatively impact both the drilling fluid and the drilling process. Moreover, such agents add to the cost of the operation, and tend to be environmentally unfriendly and render the fluid ineligible for disposal. For instance, the presence of complex surfactants, as disclosed in U.S. Pat. No. 3,455,390, would render a fluid ineligible for disposal. The present inventor has demonstrated that the wax drilling fluid additives of the present invention can be effectively dispersed in a circulating drilling fluid without the need for such additional agents. In one embodiment, the lubricating additive is dispersed in the base fluid or drilling fluid without the use of additional stabilizers, surface active additives or emulsifiers. This presents a significant economical advantage, and satisfies a strong desire in the industry for simple and affordable drilling fluid additives. The additives of the invention can also provide a significant environmental advantage, depending on the type of wax or waxy substance and the drilling fluid selected. For instance, a natural wax is considered non-toxic and biodegradable, and an aqueous drilling fluid comprising a natural wax drilling fluid additive in the absence of complex surfactants and emulsifiers, and the cuttings therein, can be fully disposable.

A person skilled in the art, having regard to the teachings herein, can select an appropriate wax or waxy substance or mixture thereof for use in manufacturing a drilling fluid additive of the invention for improving lubricity or increasing ROP in a particular drilling operation. Selection of an appropriate wax or waxy substance or mixture thereof will depend on a number of factors, including the properties of the wax or waxy substance, the base fluid selected, the structure and porosity of the underground formation, the anticipated circulating and static bottom hole temperature, and the anticipated formation and operational temperatures.

In utilizing the drilling fluid additives of the present invention in a drilling operation, one or more advantages related to improved lubricity and ROP may be achieved, including but not limited to: decreased torque and drag, decreased coefficient of friction, pinch point lubrication between the rotating drill pipe or bit and various exposed steel or rock surfaces, pinch point lubrication on drilling curves and build angles, alteration of the properties of filter cake including reduced coefficient of friction and increased stability and adhesion, decreased impact fatigue on the drill tool and drill bit, altered wettability of drill bit cutters and drill solids in an aqueous environment, decreased bit balling, increased efficiency and decreased wear on drilling equipment, decreased pipe sticking and decreased downtime in the operation.

Features of various non-limiting embodiments of the drilling fluid additive of the present invention will now be described.

The additive comprises a wax or waxy substance or mixture thereof in the form of particles. The wax is preferably selected such that the particles remain substantially solid at ambient temperature to promote storage stability and handling.

The term wax or waxy substance describes any of a variety of natural or synthetic, oily or greasy, heat-sensitive substances, consisting of, for example, hydrocarbons or esters of fatty acids that are insoluble in water. Waxes are generally hydrophobic or water-repelling. Many waxes are soluble in non-polar organic solvents, such as hydrocarbon, although the degree of solubility varies between waxes. Individual wax properties are determined by molecular size and structure, chemical composition and modification, and oil content. Physical properties that can be measured include melt and congealing points, drop melt point, hardness (i.e. needle penetration dmm @25° C.), oil content (indicates degree of refining), and kinematic viscosity. Oil content affects the solubility of a wax in an organic solvent. Wax, particularly natural wax, is generally considered non-toxic and biodegradable and therefore presents minimal disposal challenges, presenting a significant environmental benefit and cost advantage to drilling operators since treatment and disposal of drilling waste impacts the cost of the operation.

Natural waxes include waxes derived from animal, vegetable and mineral sources. Animal waxes include, but are not limited to, beeswax, lanolin, lanocerin, and shellac waxes. Vegetable waxes include, but are not limited to, soy, carnauba, candellila, jojoba, flax, sugarcane and ouricouri waxes. Mineral waxes include petroleum waxes and earth or fossil waxes, which include, but are not limited to, paraffin, petrolatum, microcrystalline, semi-microcrystalline, intermediate, ozocerite, ceresine and montan waxes. Montan waxes can be refined from such sources as lignite, humalite or brown coal.

Paraffins are natural waxes that consist mostly of straight chain hydrocarbons, typically in about the C₂₀ to C₃₅ range, the balance consisting of branched paraffins and cycloparaffins. Paraffin wax is generally non-reactive and non-toxic with good water barrier properties. The melt point of paraffin wax is generally between about 43° C. and about 65° C. (about 100° F. to about 150° C.), and some newer high melt point paraffins have melt points of about 80° C. to about 90° C. (about 176° F. to about 196° F.) or even higher.

Synthetic waxes are man-made waxes and may be derived from such sources as hydrocarbon, alcohol, glycol, or esters. They include, but are not limited to, polypropylene, polyethylene, high density polyethylene, polytetrafluoroethylene, Fischer-Tropsch, fatty acid amine, chlorinated and other chemically modified waxes and polyamide waxes.

A waxy substance is any suitable non-wax substance with wax-like properties. This would include, for example, various synthetic waxes and polymers, such as polyolefins.

Waxes or waxy substances suitable for use in accordance with the present invention may be unrefined, semi-refined (about 0.5 to about 1% oil content) or refined (less than about 0.5% oil content) waxes and do not need to be high grade. Highly refined waxes are also suitable. The wax or waxy substance may be a raw wax, a slack wax or a scale wax. Slack wax typically refers to petroleum wax containing anywhere from about 3% to about 15% oil content. Scale wax typically refers to wax containing about 1% to about 3% oil.

The drilling fluid additive may comprise particles of uniform or varying size. The particles may be microparticles or macroparticles. In one embodiment, the particles range from about 0.01 microns to about 40,000 microns in size.

In one embodiment, all or a portion of the particles are microparticles or micronized particles. In one embodiment, all or a portion of the particles are less than about 50 microns in size. In one embodiment, all or a portion of the particle range from about 0.01 to about 50 microns, or from about 0.1 to about 40 microns, or from about 0.1 to about 30 microns, or from about 0.1 to about 20 microns, or from about 0.1 to about 10 microns, or from about 1 to about 20 microns, or from about 1 to about 10 microns, or from about 1 to about 5 microns, or from about 5 to about 10 microns. In one embodiment, the particles are less than about 10 microns. In one embodiment, the particles are less than about 5 microns.

In one embodiment, all or a portion of the particles are macroparticles. In one embodiment, all or a portion of the particles are greater than about 50 microns. In one embodiment, all or a portion of the particles are from about 50 microns to about 40,000 microns, or from about 100 microns to about 30,000 microns, or from about 100 microns to about 20,000 microns, or from about 100 microns to about 10,000 microns, or from about 100 microns to about 5,000 microns, or from about 100 to about 1000 microns, or from about 100 to about 500 microns, or from about 1000 microns to about 5,000 microns, or from about 2000 microns to about 3000 microns, or from about 400 microns to about 3000 microns, or from about 400 microns to about 800 microns. In one embodiment, all or a portion of the particles are greater than about 100 microns, or greater than about 500, or greater than about 1000 microns, or greater than about 3000 microns, or greater than about 5000 microns.

In selecting an appropriate particle size range for the particles, any desired lower limit may be combined with any desired upper limit to define a suitable particle size range.

In one embodiment, the additive comprises a mixture of particles of different particle sizes. The mixture may comprise particles from various size ranges, for example, a portion of the particles may be in the microparticle range with the remaining portion in the macroparticle range. Alternatively, the additive may comprise only microparticles or only macroparticles, selected from two or more particle size ranges. For instance, a first portion of the particles may be in a first particle size range and a second portion may be in a second size range, and so on.

With a mixture of particles of different particle sizes, smaller particles will be available to access tight spaces and pinch points between the drilling tool and exposed steel or rock surfaces, as well as tight areas in and around the drill bit cutters, while larger particles will tend to remain at or near the drilling tool and wellbore wall. Larger particles are less likely to be lost to small pores and fractures in the formation. Very large particles are more likely to be rejected by solids control equipment however. Microparticles or micronized particles will not be rejected by solids control equipment and more of the microparticles will tend to integrate into the developing filter cake to thereby alter the properties of the filter cake itself. The particles can provide a temporary ball bearing-like lubricant effect, particularly if a hard wax or waxy substance having'a high melt point is selected.

It is important to note that particle size does not necessarily refer to rounded particles. The particles can be of any suitable or desired shape, such as spheres, pellets, flakes, slivers, sheets, chunks, chips, or may be irregularly shaped. The term micron is thus used to describe the general size of the particle any may refer to diameter, width, length, cross-section or the like, depending on the shape of the particle, or may be used to describe the dominant dimension of the particle.

In one embodiment, the particles are spherical beads. In another embodiment, the particles are flakes, which have increased surface area and tend to join together to form layers. In certain embodiments, the additive may comprise a mixture of particles having different shapes. It is understood that, depending on temperature fluctuations, solubility factors, mechanical or shearing forces encountered, the shape and size of the particles may be altered after they are pumped downhole. Such post facto alterations do not deviate from the Scope or intent of the present invention to the extent that the fluid or operation is not negatively impacted by such alterations.

The drilling fluid additive of the present invention may comprise a mixture of different types of particles. Different types referring to particles having one or more distinct properties from one another, such as particle size, type of wax or waxy substance, melt point, solubility, dissolution rate, hardness, shape, blocking ability, or a combination thereof. The different types of particles may be selected to provide specific functions during the drilling operation.

Where the additive comprises more than one distinct type of particle, the particles may be combined in any suitable ratio. For example, where two types of particles are combined, a ratio of about 100:1 to about 1:100, about 25:1 to about 1:25, 10:1 to about 1:10, about 5:1 to about 1:5, or about 2:1 to about 1:2, may be selected. In one embodiment, two types of particles are combined in a ratio of about 1:1 by weight. In another embodiment, two types of particles are combined in a ratio of about 2:1. Where more than two types of particles are combined, any suitable ratio may be selected. In one embodiment, the additive comprises three types of particles combined in a ratio of about 1:1:1.

The melt point, or melting temperature, of a particular wax or waxy substance selected is an important consideration in designing a suitable additive for a particular operation. The additive may comprise a mixture of two or more types of particles having different melt points. Such a mixture can be manufactured by those of skill in the art and tailored to a particular drilling operation and formation. The materials can be selected based on, for example, anticipated bottom hole temperature, anticipated formation temperatures, anticipated operational temperatures, or the like.

In accordance with the present invention, the particles remain substantially solid at ambient temperature for ease of handling and storage. Substantially solid in this context means that the particles will not permanently block together or melt under typical storage and handling conditions. If desired, the particles may be treated by means known in the art to improve the storage and handling properties of the particles at ambient temperatures so long as the treatment does not negatively impact the intended function of the particles. In preferred embodiments, the particles have melt points above typical storage and handling temperatures, for example, above about 25° C., or above about 30° C., or above about 35° C., or above about 40° C., or above about 50° C., or above about 60° C.

In one embodiment, all or a portion of the particles remain substantially solid throughout the drilling procedure. By this it is generally meant that the particles will not dissolve or melt in the drilling fluid or permanently liquefy downhole at the temperatures encountered during the drilling operation, although it is understood that a portion of the additive may liquefy at particular areas of high temperature such as pinch points. In some embodiments, the melt point of the all or a portion of the particles is selected such that it is higher than the expected operational temperatures encountered during drilling—i.e. the temperatures in the circulating drilling fluid, flowlines, drilling equipment, the developing well bore and the circulating bottom hole temperature (BHT)—such that the additive stays substantially solid during the entire drilling procedure. In one embodiment, the particles have a melt point at least about 5° C., or at least about 10° C., higher than the highest operational temperature anticipated during drilling.

In one embodiment, the all or a portion of the particles are substantially insoluble in the drilling fluid at temperatures below the melt point of the particles. This may be achieved, for instance, by selection of a suitable wax or waxy substance. The particles may be designed such that relatively little of the additive will dissolve or melt in the drilling fluid at the temperatures experienced during a typical drilling operation. Of course, at areas of high temperature, such as pinch points, the additive may become liquefied and provide a liquid lubricant effect at that location. By substantially insoluble, it is generally meant that less than about 30%, preferably less than about 10%, more preferably less than about 5%, most preferably less than about 1%, of the additive will dissolve in the fluid during the course of a drilling operation when the fluid temperature is below the melt point of the particles.

In one embodiment, all or a portion of the particles are substantially insoluble in hydrocarbons at temperatures below their melt point. This is particularly advantageous when drilling with a hydrocarbon based fluid if it is preferred that the particles remain in a substantially solid form during the drilling operation. Controlling the solubility of the particles in hydrocarbons will also ensure that the formation hydrocarbons do not become excessively contaminated with dissolved wax or waxy substance.

When used in an oil and gas drilling operation, it is preferable that the additives of the present invention do not have a permanent or damaging effect on the formation or on well production. To assist in removal of residual additive from the formation upon completion of well drilling, the particles can be designed such that all or a portion of the particles will melt at a geothermal temperature of an underground formation. This can be achieved, for instance, by selection of a suitable wax or waxy substance. As used herein, geothermal temperature refers to the natural temperature in an underground formation or at a particular location in an underground formation, such as a production zone. During a drilling operation, the circulating drilling fluid tends to have a cooling effect on the formation such that the temperature of the formation near the wellbore during the operation is cooler than geothermal temperature. In one embodiment, the wax or waxy substance is selected such that the particles have a melt point below the geothermal temperatures expected in the formation, particularly at a production zone where removal is most important. At a production zone, geothermal heat will liquefy some or all of the residual additive and fluid or gas pressure from the formation would assist in moving the additive out of or away from the production zone. Depending on the wax or waxy substance selected, the melted additive can go into solution with the formation hydrocarbons and can be produced with the hydrocarbons from the production zone a component of the hydrocarbon resource. Depending on the properties of the wax or waxy substance selected, the additive may remain substantially in solution with the hydrocarbons until optionally removed therefrom. All or a portion of the additive may alternatively crystallize or solidify in the produced hydrocarbons as the temperature is decreased below melt point. In some cases, it may be preferred to select an wax or waxy substance that will remain in solution with the produced hydrocarbons or that will form only small crystals in the hydrocarbons. This has added benefit to an operator or user since accretion of the produced hydrocarbons in an undesirable location, such as a production platform, in piping, or at a storage or other facility, will be not be a concern. In many cases, the residual additive will form only a minor component of the produced hydrocarbons such that accretion will not be of concern. The additive can be later removed from the produced hydrocarbons if desired.

The particles may be designed such that they all or a portion thereof will remain substantially solid at the operational temperatures encountered during drilling but will melt over time upon completion of the operation due to geothermal heat from the formation. For example, if a wax is selected such that it has a melt point above the anticipated operational temperatures but below the anticipated geothermal temperature of the formation, particularly at a production zone, the wax will remain substantially solid during the drilling operation but will later be removable from the formation with the assistance of geothermal heat. For instance, if the highest operation temperature anticipated during drilling is about 60° C. and the geothermal formation temperature at a production zone is expected to be about 90° C., that particles could be engineered to have melt points at least about 5° C. above the operational temperature and at least about 5° C. below the geothermal temperature, or between about 65° C. and about 85° C.

If the particles are also substantially insoluble in hydrocarbons, any residual additive will be easily removable from recovered hydrocarbons at temperatures below melt point. Different waxes and waxy substances have different solubility in hydrocarbon fluids and smaller particles tend to have higher rates of dissolution than larger particles. The dissolution rates of wax particles in hydrocarbon oil are affected by previous exposure of the oil to wax having a saturation effect. Thus, the dissolution rate of additive that is added to a recycled base oil or invert fluid can be decreased compared to the dissolution rate in fresh oil due to the presence of finely dispersed wax particles or dissolved or melted wax in the recycled fluid.

A skilled person can anticipate the temperatures that will be encountered in a given drilling operation based on past experience and records from a particular drilling location. The temperature in the wellbore typically increases as the well deepens or as the permeability of the formation decreases, although hot spots may be encountered where the temperature can exceed the deepest well temperature, or bottom hole temperature (BHT). A typical BHT in Western Canada is between about 55° C. to about 90° C., and is generally about 65° C. Temperatures at the surface are generally about 15° C. lower. The particles may be manufactured to have a melt point above anticipated BHT, for example, at least about 5° C. above BHT, at least about 10° C. above BHT, at least about 30° C. above BHT, or at least about 90° C. above BHT. The higher the anticipated BHT, the higher the melting point of the selected wax or waxy substance selected if the material is to remain substantially solid during the drilling operation. In one embodiment, all or a portion of the particles have a melt point above about 40° C., or above about 65° C., or above about 70° C., or above about 85° C.

In some embodiments, all or a portion of the particles have melt points in the range of from about 10° C. to about 180° C., or about 30° C. to about 160° C., or about 60° C. to about 160° C., or about 65° C. to about 160° C., or about 70° C. to about 160° C., or about 80° C. to about 150° C., or about 85° C. to about 140° C., or about 90° C. to about 140° C. In one embodiment, all or a portion of the particles have melt points between about 65° C. and about 95° C. In one embodiment, all or a portion of the particles have a melt point between about 69° C. and about 95° C.

In certain embodiments, waxes having a melt point of 65° C. or above are preferred for drilling operations where the BHT is anticipated to be about 65° C. or lower.

Although there is no absolute upper limit for the melt point of the particles, other properties of the wax or waxy substance, such as hardness, may be affected as the melt point increases and should be considered in engineering the additive.

Depending on the materials selected and the drilling and formation conditions, the particles may exhibit a blocking effect, wherein particles join together to form layers, stacks, chunks, blocks or other formations. Blocking ability is determined by the properties of the particular wax or waxy substance selected and may be encouraged by heat, momentum, or pressure generated during the drilling process. Blocking contributes to the ability of wax to join together to form protective coatings or layers on the drilling equipment, the filter cake or the wellbore, which is assisted by mechanical forces and pressure differentials. Thin layers of wax provide beneficial lubricant effects and can also protect upper hole casing strings, increasing the overall life of the steel casings. Movement of the drill pipe can wear a hole in casing strings, particularly in the upper hole casings, causing considerable expense to repair. A protective layering of the additive can provide protection to the steel casing even if that is not the primary objective.

The malleability or deformability of the particles plays a role in determining its blocking ability. Generally speaking, softer waxes exhibit better blocking ability than harder waxes. Particles exhibiting higher blocking ability would be particularly useful where it is desired to form a lubricating coating on a surface, such as the surface of the wellbore, filter cake, drilling tool, casings, or cuttings. Harder particles can exhibit properties more typical of a solid lubricant at temperatures below melt point and tend to remain longer in solid particle form in the fluid or filter cake than softer particles. The relative hardness or softness of a particular material will of course be affected by the temperatures to which the material is subjected and it is within the ability of a skilled person to select a material or materials having suitable properties for a given operation based on the teachings herein.

It is thus important to select a wax or waxy substance that has a suitable hardness for a particular application. Hardness can be measured in a standardized needle penetration test and may be expressed in units of needle penetration (dmm) at 25° C., where a lower hardness value represents a harder material. In certain embodiments, all or a portion of the particles have a hardness of less than about 25 dmm at 25° C., or less than about 20 dmm at 25° C., or less than about 15 dmm at 25° C., or less than about 10 dmm at 25° C., or less than about 5 dmm at 25° C., or less than 4 dmm at 25° C., or less than about 2 dmm at 25° C., or less than about 1 dmm at 25° C.

In some embodiments, the additive comprises two or more distinct types of particles, having different hardness. For instance, softer wax particles may be selected for providing lubricating coatings or layers on metal and rock surfaces (i.e. casing, drill pipe, bit, wellbore wall or cuttings), and these softer particles may be combined with harder wax particles which exhibit at least a temporary bead-like or ball bearing-like effect at temperatures below melt point to relieve torque and drag downhole. In some embodiments, the harder wax particles are selected to have a higher melt point than the softer particles.

The tackiness of a given wax or waxy substance is another factor to consider in selecting a suitable lubricating additive for use in accordance with the present invention. In general, materials with lower coefficients of friction are preferred in a drilling operation due to lower torque and drag issues when the drill pipe is in the hole. This is especially important in directional or horizontal drilling. In certain embodiments, waxes or waxy substances with low coefficients of friction are preferred. In one embodiment, the particles are engineered such that they exhibit minimal interference with solids control or with directional drilling equipment, which is vital to many drilling operations. Many known products currently added to fluids in an effort to increase lubricity interfere with the equipment, causing fluid and operational problems. In one embodiment, the drilling fluid additive has minimal effect on the drilling fluid properties or the drilling operation.

Construction of a suitable drilling fluid additive in accordance with the present invention is thus based on consideration of several variables, including: the physical and chemical properties of the wax or waxy substance(s) selected in the manufacture of the particles, other characteristics of the particles such as size and shape, the properties of the drilling fluid and the nature of the drilling operation, the characteristics of the formation being drilled, as well as cost considerations and availability of materials.

Waxes and waxy substances are available in a wide range of melt points, hardness, density, viscosity, etc. for engineering of particles having optimum performance for a particular operation. Waxes and waxy substances may be provided by any suitable supplier. Two exemplary suppliers include International Group Inc. (IGI), Ontario, Canada, and Marcus Oil and Chemical (Marcus).

Non-limiting examples of commercially available waxes suitable for use in accordance with the present invention are illustrated below.

Examples of Refined Parrafin Waxes

| | Typical Hardness | | |
|---|---|---|---|
| Melt Point (° C.) | (dmm @ 25° C.) | Supplier | Supplier Product Code |
| 53.9 | 17 | IGI | IGI 1070A |
| 54.4 | 14 | IGI | IGI 1230A |
| 55.6 | N/A | IGI | IGI 1236A |
| 54.4 | 12 | IGI | IGI 1325A |
| 58.9 | 12 | IGI | IGI 1239A |
| 57.8 | 11 | IGI | IGI 1240A |
| 59.4 | 11 | IGI | IGI 1242A |
| 60 | 13 | IGI | IGI 1245A |
| 61.4 | 11 | IGI | IGI 1250A |
| 60 | 12 | IGI | IGI 1302A |
| 58.9 | 13 | IGI | IGI 1343A |
| 67.8 | 14 | IGI | IGI 1303A |
| 67.2 | N/A | IGI | IGI 1380A |
| 69.4 | 12 | IGI | IGI 1260A |

N/A = information not available

Examples of Microcrystalline Waxes

| Melt Point | Hardness | | |
|---|---|---|---|
| (° C./° F.) | (dmm at 25° C.) | Supplier | Supplier Product Code |
| 60/140 | 40 | IGI | MICROSERE 5788A |
| 70/160 | 28 | IGI | MICROSERE 5701A |
| 70/160 | 28 | IGI | MICROSERE 5714A |
| 77/170 | 28 | IGI | MICROSERE 5715A |
| 77/170 | 28 | IGI | MICROSERE 5799A |
| 83/181 | 18 | IGI | MICROSERE 5818A |
| 83/181 | 18 | IGI | MICROSERE 5871A |
| 83/181 | 18 | IGI | MICROSERE 5890A |
| 84/183 | 14 | IGI | MICROSERE 5981A |
| 87/188 | 18 | IGI | MICROSERE 5897A |
| 87/188 | 18 | IGI | MICROSERE 5896A |
| 89/192 | 9 | IGI | MICROSERE 5901A |
| 90/194 | 8 | IGI | MICROSERE 5999A |
| 90/194 | 8 | IGI | MICROSERE 5909A |
| 90/194 | 8 | IGI | MICROSERE 5910A |

Examples of Soy and Palm Waxes

| Melt Point | Hardness | | |
|---|---|---|---|
| (° C./° F.) | (dmm at 25° C.) | Supplier | Supplier Product Code |
| 59.4/139 | 13 | IGI | IGI R2322A |
| 53.9/129 | 11 | IGI | IGI R2778A |
| 57.2/135 | 9 | IGI | IGI R2779A |

Examples of Polyethylene Waxes

| Mettler Drop Point | Hardness | | |
|---|---|---|---|
| (° C.) | (dmm at 25° C.) | | Supplier Grade |
| ASTM D3954 | ASTM D1321 | Supplier | Code |
| 118 | 2-3 | Marcus | M200 |
| 118 | 2-3 | Marcus | M300 |
| 118 | 2-3 | Marcus | M500 |
| 106 | 2-3 | Marcus | MC6 |
| 98 | 2-3 | Marcus | MC16 |
| 112 | 4 | Marcus | M3300 |
| 112 | 4 | Marcus | M3400P |
| 112 | 4 | Marcus | M3400T |
| 112 | 5 | Marcus | M3500 |
| 137 | <0.5 | Marcus | MC330 |

Examples of Micronized Polyethylene Waxes

| Mettler Drop Point | Hardness | Average | | Supplier |
|---|---|---|---|---|
| (° C.) | (dmm at 25° C.) | Particle Size | | Grade |
| ASTM D3954 | ASTM D1321 | (microns) | Supplier | Code |
| 137 | <0.5 | 6 | Marcus | M6 |
| 137 | <0.5 | 12 | Marcus | M12 |
| 118 | 2 | 5 | Marcus | M5005 |
| 118 | 2 | 10 | Marcus | M5010 |
| 118 | 4 | 10 | Marcus | M3310 |

Other suitable waxes include various wax products sold for industrial and cosmetic applications.

In one embodiment, all or a portion of the particles comprise polyethylene wax or a derivative thereof. In one embodiment, all or a portion of the particles comprise microparticles of polyethylene wax having a melt point above 90° C. and a hardness of less than 10 dmm at 25° C.

In one embodiment, all or a portion of the particles comprise vegetable or mineral wax or a derivative thereof.

In one embodiment, the vegetable wax is refined soy wax having a melt point above 65° C. (ex. Marcus N5010) or a vegetable wax product having a melt point above 65° C. (ex. Marcus NAT 180).

In one embodiment, the mineral wax is a paraffin wax or a microcrystalline wax. In one embodiment, the particles comprise refined or highly refined paraffin or microcrystalline wax. In one embodiment, all or a portion of the particles comprise refined or highly refined paraffin wax. In one embodiment, all or a portion of the particles comprise microcrystalline wax.

In one embodiment, all or a portion of the particles comprise refined paraffin wax having a melt point between about 60° C. and about 70° C.

In one embodiment, the additive is a mixture of 400-800 micron particles of refined paraffin wax having a first melt point and hardness (ex. 65° C. MP, 11-14 dmm penetration) and 2000-3000 micron particles of refined paraffin wax having a second melt point and hardness (ex. 69.4° C. MP, 12-18 dmm penetration). In one embodiment, these waxes are combined in a ratio of about 2:1 by weight.

In one embodiment, the additive comprises a mixture of particles of paraffin and microcrystalline waxes. In one embodiment, the additive comprises a mixture of 100 to 3000 micron particles of paraffin wax (65° C. MP, 11-14 dmm penetration) or microcrystalline wax (ex. 90° C. MP, 14-18 dmm penetration).

In one embodiment, the additive is a mixture of paraffin and microcrystalline waxes, where the microcrystalline particles are larger than the paraffin particles. In one embodiment, the mixture comprises 400-800 micron particles of refined paraffin wax (ex. 65° C. MP, 11-14 dmm penetration) and 2000-3000 micron particles of refined microcrystalline wax (ex. 90° C. MP, 14-18 dmm penetration).

Where the additive comprises a mixture of particle types, it is important to note that the individual particle types may be manufactured or sold as a blend of particles, or the particle types may be manufactured or sold individually and mixed by a purchaser, operator or user prior to drilling or during the drilling operation. The particles do not need to be mixed together per se but may be added to the circulating drilling fluid or downhole in various relative proportions or ratios throughout the course of the entire drilling operation.

In certain embodiments, the additive is dispersed in a drilling fluid without the use of surface active agents or emulsifiers which can negatively impact the fluid properties or present disposal challenges. Of course, a skilled person may still elect to use such additives where appropriate or desired.

In one embodiment, the drilling fluid is viscosified. The inventor has found that viscosifying the drilling fluid,.for example with polymers, clays or gels, enhances dispersion or suspension of the wax particles in a base fluid. It has also been found that the drilling fluid can be effectively viscosified with wax or waxy substance, which may be in the form of dissolved or liquified wax or waxy substance or fine particles. In one embodiment, the drilling fluid is viscosified using wax or waxy substance. In a field test, it was found that the presence of melted wax or dispersed wax particles had a positive effect on an invert emulsion, providing additional viscosity and yield, and also increasing the electrical stability of the emulsion. Furthermore, the test operator was able to reduce the amount of costly clay-type viscosifiers traditionally used, thereby reducing costs to the operator. Thus, liquid wax or finely dispersed wax particles may be used to viscosity a drilling fluid. In some embodiments, the drilling fluid additive of the invention may serve to viscosity the drilling fluid thereby aiding its own dispersion. Where a portion of the particles break down or become partially melted or dissolved over time during a drilling operation, this would add viscosity to the fluid.

An operator may choose to viscosity the fluid by exposure to or saturation with a dissolved or liquefied (i.e. soluble or melted) wax prior to addition of the drilling fluid additive of the invention to enhance dispersion or decrease the dissolution rate of the additive. A liquid wax may be used, or a solid wax may be liquefied prior to being added to a base fluid or drilling fluid, or may be selected to have a lower melting point than the temperature of the fluid such that it melts after addition, or such that it melts downhole. Alternatively, the temperature of the base fluid or drilling fluid can be adjusted to affect the properties of the particles. If a liquefied or melted wax is used, it may be a hydrocarbon-insoluble wax such that it can be easily removed from formation hydrocarbons if desired. A skilled operator can expose the fluid to wax to achieve beneficial effects on viscosity and electrical stability with minimal negative effects, such as a negative effect on the cold pour point of the base fluid, particularly base oil, which would cause cold weather problems. The solution will increase in congealing point at lower temperatures as more wax is added. If too much wax is added, the entire solution will congeal upon cooling rather than the wax simply precipitating out of solution.

In one embodiment, the additive is designed such that the particles are added to the base fluid or drilling fluid in a solid form and melt at the temperatures encountered during drilling.

In one embodiment, the additive comprises a mixture of particles having different melt points, wherein a portion of the particles will melt downhole during the drilling operation and another portion will remain substantially solid. For example, if the operation temperatures downhole are expected to reach 65° C., a portion of the particles could have a melt point of about 60° C. or less and another portion of particles could have a melt point above about 70° C. If geothermal removal of residual additive is desired, all of the particles will have a melt point less than the formation temperatures expected, particularly at production zones.

In one embodiment, the additive is heated above its melting point prior to being added to the carrier fluid or drilling fluid as a liquid or semi-liquid spot treatment. The spot treatment can be designed such that it will solidify downhole on metal or rock surfaces to provide a lubricating coating where needed.

In certain preferred embodiments, the drilling fluid additives are non-toxic and biodegradable with no handling or exposure issues.

In certain embodiments, the additives have low density and do not require oil-wetting additives for addition to the drilling fluid.

In one embodiment, the drilling fluid additive of the invention is the only lubricant or ROP enhancer in the fluid system.

Drilling fluid comprising the drilling fluid additive of the invention may optionally include one or more secondary lubricating additives selected from known liquid and solid lubricants.

Drilling fluid may optionally include one or more other additives or inhibitors commonly used in the industry. Additives for drilling fluids fall into several basic groups. These include, but are not limited to, viscosifiers; weighting additives; surface active additives; emulsifiers; oil wetting additives; alkalinity control additives; lost circulation materials; thinners or dispersants; flocculants; defoamers; lubricants; shale inhibitors; and corrosion inhibitors.

Drilling fluid may optionally include lost circulation materials, such as organic fibers, ground organic fibers, sawdusts, uintaite (e.g., Gilsonite™), asphalt, cellophane, plastics, calcium carbonate, sulfonated asphalt, sulfonated uintaite or combinations of any of these or other known materials.

The drilling fluid additive may be added to a base fluid or to a drilling fluid. The drilling fluid additive may be dispersed or suspended in a suitable carrier liquid prior to being added to a base fluid or a drilling fluid.

The drilling fluid additive may be added to base fluid or drilling fluid prior to or after the addition of other common additives, using methods known to those skilled in the art. The additive may be added to a base fluid or drilling fluid that already contains common drilling fluid ingredients. The additive may be added at any stage in the formulation of the drilling fluid composition by methods known to those skilled in the art.

In certain embodiments, the drilling fluid additive is present in a drilling fluid at a concentration of about 0.01 kg/m³ to about 500 kg/m³ at a point in the drilling operation. In referring to the concentration, the volume refers to the volume of fluid before addition of the additive, i.e. add 10 kg to 1 m³ of fluid for 10 kg/m³. The amount of additive added to the fluid, and the rate at which it is added, will depend on expected characteristics of the operation or formation, or real-time torque and drag experienced at a particular location in a formation. It is considered within the ordinary ability of a person skilled in the art to select an appropriate concentration of additive and a suitable addition regimen for a given drilling operation and formation, based on the teachings herein.

In certain embodiments, the concentration of additive in a drilling fluid may range from about 1 kg/m³ to about 200 kg/m³, from about 1 kg/m³ to about 100 kg/m³, from about 1 kg/m³ to about 50 kg/m³, from about 5 kg/m³to about 30 kg/m³, or from about 5 kg/m³to about 20 kg/m³. In some embodiments, a concentration of less than 50 kg/m³ in the drilling fluid is preferred for minimal effect on the drilling fluid or the drilling operation.

The additive may be added to a base fluid and stored prior to use, for example, as a mixture, dispersion or suspension. The base fluid may optionally be subjected to treatment, such as mixing, agitation or shearing, prior to formulation of the drilling fluid. Such treatment may have the effect of further dispersing the particles or may alter the particle size somewhat.

In the field, the drilling fluid additive is not necessarily added based on a typical concentration range given the fact that not all of the material stays in the system. Some of the additive may be lost to the formation or removed by solids control equipment on return to the surface for instance. Operators are familiar with this and can adjust the addition regime accordingly throughout the procedure. The additive may be added in units of sacks per meters drilled. The skilled operator knows the rate of drilling and can easily calculate how fast to add the material or when to spot the material to a particular location, such as a pinch point, during the operation.

The present invention also relates to a method of improving lubricity or ROP in a drilling operation. In the oil and gas industry, the drilling operation will typically involve the drilling of a well into an oil or gas bearing subterranean formation.

The general method involves adding the drilling fluid additive of the present invention to a drilling fluid, and using the drilling fluid comprising the additive in a drilling procedure to enhance lubricity or increase ROP.

The method may be a preventive method, a treatment method, or a combination of both. IN a preventive method, the additive can be added to the base fluid or drilling fluid prior to-drilling or prior to reaching an anticipated location of high torque and drag. In a treatment method, the additive can be added to the drilling fluid while drilling ahead when surges of high drag or torque are experienced.

The drilling fluid additive may be added to mixing tanks prior to circulation, or may be added while drilling ahead. The additive may be added as a single addition prior to drilling, or may be added continuously or intermittently throughout the operation. Typically, an initial volume of additive is added to the base fluid or drilling fluid prior to drilling and additional volumes are added throughout the drilling operation, as needed. The concentration of lubricating additive in the drilling fluid is adjusted throughout the procedure to account for sudden changes in torque and drag that are experienced.

In the event of anticipated or real-time surges in torque and drag, pill volumes or spot treatments of the lubricating additive are added to the drilling fluid and pumped downhole. A pill volume is a discrete high concentration of lubricating additive that is added to the drilling fluid. Pill volumes may optionally be dispersed in a carrier fluid.

The drilling fluid additives of the present invention may be utilized with any suitable drilling fluid system. Examples of industry recognized mud systems include but are not limited to: hydrocarbons; invert emulsions, which are hydrocarbon based; aqueous based systems; aqueous based emulsions; potassium chloride or potassium sulfate systems, which are water based; silicate systems, which are water based; amine systems, which are fully disposable; PHPA or polyacrylamide systems, which provide shale inhibition and are fully disposable; and synthetic systems. Each type of system has its own advantages and disadvantages, as will be appreciated by the person skilled in the art.

The drilling fluid additive of the present invention is suitable for use in various drilling procedures and operations, including vertical well drilling, horizontal well drilling, or directional well drilling. The drilling operation may be an oil and gas operation, a mining operation, or another operation where drilling is utilized and where improved lubricity or ROP is desired. The additives are useful in drilling operations on land or offshore. The drilling fluid additives described herein are also suitable for drilling under difficult hole conditions, such as in unstable or underpressured formations, due to the many advantageous properties described above.

### EXAMPLE 1

Lubricity Test Using Wax as a Lubricant

The lubricity of particles of refined paraffin wax (IGI 1255, International Group Inc.) was tested using an OH Lubricity Tester Model 111-00. The standard lubricity tester consists of means of applying a known force normal to two mated steel surfaces. The lubricity tester mates a 1″ diameter ¼″ tall steel ring to a block of steel with a ¼″ long arc matching the diameter of the ring. The two pieces of steel are pressed together with 150 lb inch of torque, and the force required to turn the steel ring on a shaft is measured while the ring and block are immersed in the fluid of interest at 60 rpm.

The clearance between the test surfaces is very narrow. A consequence of this standard design is that standard lubricity measurements are limited to materials that are either water soluble or will coat the steel surfaces through adsorption. Since the wax particles to be tested were not water soluble and would not adsorb onto the steel, a modification of the standard lubricity test was made, wherein beads of wax were physically placed between the two test surfaces by detaching and reattaching the two metal test surfaces prior to running the test.

The results of the modified test indicated that the wax particles reduced the coefficient of friction (CF) on the two steel surfaces. The definition of coefficient of friction (CF) is CF=F/W, where F is frictional force and W is the force applied normal to the two surfaces. For untreated deionized water, CF=33-36. Lubricity measurements of drilling fluids generally report torque reduction, where torque reduction is defined as % torque reduction=(A−B)/A×100, where A is CF for water and B is CF for the fluid being tested.

CF was measured for deionized water at 60 rpm and was found to be 34, within the expected range. The applied force on the surfaces was removed and particles of wax were placed between the two test surfaces. The force was then reapplied to the steel surfaces, the apparatus was re-immersed in deionized water and CF was recorded at 60 rpm. CF was measured at 9.4 initially but climbed throughout the duration of the test to 34, presumably due to removal of the wax from the steel surfaces. In a drilling operation, the lubricating drilling fluid additive could be continually circulated or otherwise applied as needed.

Using the value of 9.4, torque reduction was calculated as follows: % torque reduction =(34−9.4)/(34)×100=72.3%. This represents a significant decrease in torque using the wax lubricant in a laboratory test environment.

### EXAMPLE 2

Field Testing of Wax Drilling Fluid Additive and Reported Effects on Torque, Drag and ROP

A drilling fluid additive of the present invention was tested in the drilling of horizontal wells using an invert drilling fluid in a well-defined drilling area and drilling operation. The company employed to conduct the test had drilled many horizontal wells in the area and was very familiar with the typical drag, torque and rates of penetration (ROP) encountered while drilling, including those encountered during the curves or build angle section to horizontal or 90 degrees.

The particular additive tested was a blend of blend of 400-800 micron refined paraffin wax particles (IGI 1255) and 2000-3000 micron refined paraffin wax particles (IGI 1260) in a ratio of about 2:1 by weight. Addition of the additive to the drilling fluid during the drilling operation ranged from about 10-20 kg/m³. When totaled for the duration of the operation, the average was about 150 m³ of drilling fluid and about 100-120 sacks (22.7 kg/sack) of additive. Additions can also be measured in terms of sacks per 100 meters of new hole drilled. The skilled operator knows the rate of drilling and can quickly calculate how fast to add the material or when to spot the material to a particular location, such as in pill form to provide pinch point lubrication at a desired point.

Drawing on previous experience in drilling the same well profile under the same conditions in the same area, the operator reported that torque and drag readings while drilling the curves were reduced by 40-50% while running the wax additive of the present invention, compared to previous wells drilled in the area without the addition of the wax lubricant. Furthermore, the operator reporting a surprising 10-20% increase in ROP. Changes in ROP are not necessarily predictable based on lubricity alone and can be attributable to other factors beyond improved lubricity. These results demonstrate the significant practical effects of a drilling fluid additive of the invention when applied in the field.

### EXAMPLE 3

Baseline ROP Data for Drilling Operations in Particular Drilling Area

To establish baseline ROP for a particular well-defined area in Alberta, Canada, bit records for several wells drilled within a few miles of each other over a period of three years were obtained from United Diamond. The same style and size of drill bit, a United Diamond 222 mm PDC bit (ID: 222UD513), was used for all of the runs shown in Table 1 below. Table 1 shows bit record data at different In and Out depths for runs from several wells drilled in the area using standard drilling methods. These records give a good baseline from which to draw comparisons for the area. Based on the results from Table 1, average ROP in the area is about 9.23 m/hr.

Bit Records for Previous Wells Drilled in Area

| | IN | OUT | Drilled | | ROP |
|---|---|---|---|---|---|
| Run # | (m) | (m) | (m) | Hours | (m/hr) |
| 1 | 601 | 1647 | 1046 | 56.00 | 18.68 |
| 2 | 611 | 1521 | 910 | 123.00 | 7.40 |
| 3 | 615 | 1666 | 1051 | 107.25 | 9.80 |
| 4 | 619 | 1651 | 1032 | 100.00 | 10.32 |
| 5 | 2188 | 2318 | 130 | 11.25 | 11.56 |
| 6 | 2195 | 2388 | 193 | 31.00 | 6.23 |
| 7 | 2197 | 2445 | 248 | 30.25 | 8.20 |
| 8 | 2296 | 2335 | 39 | 5.50 | 7.09 |
| 9 | 2342 | 2353 | 11 | 1.25 | 8.80 |
| 10 | 2474 | 2560 | 86 | 20.25 | 4.25 |

### EXAMPLE 4

Effect of Wax Drilling Fluid Additive on ROP and Rotating Hours in the Field

The aim of the field test was to simultaneously drill a test well and a control well in the same area noted above in Example 3 using a water based fluid system. In the test well, the fluid system was supported by a drilling fluid additive of the invention comprising particles of refined paraffin wax. In a typical operation in this area, a water based silicate mud system is used due to severe shales in the upper hole with the addition of traditional lubricants. Operators must dispose of the mud system and all the solids excavated from the wellbore offsite at a controlled landfill facility, which adds to the cost and environmental impact of the operation. Surface casing is set to a normal depth using water based fluid without silcate. Operators then drill down to about 2000 meters using the silicate fluid to run the next string of casing, the intermediate casing string, which is put in place to hold back the well in this area and is a costly part of the well program. Operators then drill out with the silicate fluid and drill ahead to a total depth of about 2500 meters and run the final casing string. These wells are programmed with an expectation of about 28 days from spudding to rig release.

It was decided to drill the test well without silicates and traditional lubricants to advantageously create a drilling fluid that was fully disposable. This was believed to be possible due to the ability of the wax to form a hydrophobic barrier on the wellbore wall to inhibit hydration of shales and promote hole stability. Amines were also present in the fluid system to further inhibit hydration in a disposable system.

The test and control wells were drilled simultaneously and in close proximity by an operator running two drilling rigs under the same engineering conditions with the same well profile. The drill bit used for both wells was a United Diamond 222 mm PDC bit (ID: 222UD513), as in Example 3.

The test well was spudded and the normal surface hole was drilled with no problems. The upper hole was drilled out and then drilling was continued running the wax drilling fluid additive. The density was increased from 1030 kg/m³ to 1145 kg/m³ prior to reaching the intermediate casing depth. The operators were able to drill through and past the intermediate casing point to total depth. The hole was then conditioned and the casing was run to total depth, avoiding the intermediate casing altogether, which could be due in part to increased hole stability caused due to wax build up on the wellbore wall and in permeations in the formation. Significant increases in ROP were experienced in the test operation and the well was completed in 16 days—a full 12 days under the expected AFE (Authorization for Expenditure) and drilling time, and at a significantly lower operational cost. The drilling fluid cost was decreased, due to the absence of costly silicates and traditional lubricants, and the mud system and cuttings were fully disposable. Furthermore, the cost and time of running the intermediate casing was avoided. This was the fastest run in the area to date.

Table 2 shows the bit record data from two runs of the test and control wells. Runs 1 and 2 show results for the control well drilled from 630 m to 2503 m using a water based silicate mud system with traditional lubricants. Runs 3 and 4 show results for the test well drilled from 622 m to 2505 m using a using the refined paraffin wax additive without silicates or traditional lubricants. On the initial run with the wax additive (Run 3), the operator was able to drill 159 meters further than the initial run for the control well (Run 1) before having to remove the bit from the well. Without being bound by a particular theory, this enhanced bit performance is likely due in part to increased lubricity at the drill bit and cutters, reduced bit impact fatigue, altered wettability of the cutters, reduced bit balling, or a combination of the above. Furthermore, the operator was able to complete the entire test well in 143 rotating hours, compared to 227 rotating hours for the control well, thus a full 84 rotating hours earlier. The average ROP for the control well was 8.25 m/hr (1873 m/227 hrs). The average ROP for the test well drilled with the wax additive was 13.17 m/hr (1883 m/143 hrs). This is an increase in ROP of approximately 60% using the wax additive of the present invention compared to the control well. Such an increase in ROP and decrease in downtime has significant impact for operators on both the time and the cost associated with a drilling a well. Moreover, the additive is biodegradable and environmentally friendly and in this case the drilling fluid system was fully disposable.

Bit Record Data for Control and Test Well

| | IN | OUT | Drilled | | ROP |
|---|---|---|---|---|---|
| Run # | (m) | (m) | (m) | Hours | (m/hr) |
| 1 | 630 | 2200 | 1570 | 166.50 | 9.43 |
| 2 | 2200 | 2503 | 303 | 60.50 | 5.01 |
| 3 | 622 | 2351 | 1729 | 125.75 | 13.75 |
| 4 | 2351 | 2505 | 154 | 17.25 | 8.93 |

United Diamond has established a performance number for drill bit performance, calculated based on several parameters, where a higher performance number indicates better performance. Prior to the field tests using the drilling fluid additive of the present invention, the previous record performance numbers for this type of PDC bit in this area were 127 and 199. About 10 years of drilling optimization was involved in achieving these performance numbers. In the test well drilled using the wax additive of the invention, record performance numbers of 315 (Run 3) and 323 (Run 4) were achieved.

### EXAMPLE 5

Simulation of Geothermal Removal of Microcrystalline Additive from a Production Zone

Permeability Plugging Tests (PPT) were performed using ceramic filtration discs of known permeability and porosity (10 Darcy, 90 microns). The experiment was designed to simulate a production zone of an underground formation and to determine the effect of wax particles on formation permeability and the effect of geothermal heat on removal of wax from a production zone in a formation.

The drilling fluid additive used in the tests consisted of a mixture of medium size microcrystalline particles and course sized microcrystalline particles having a melt point of 90° C. in a ratio of 1:1 by weight. The particles were added to a water-based polymer mud at a concentration of 15 mg/kg or 30 mg/kg. Tests at both concentrations included 15 mg/kg Rev Dust™ (a simulated drilling solid for lab testing procedures).

The discs were placed inside the cell and the polymer mud containing the wax particles was filtered through the disc at 40° C., i.e. lower than production temperatures, aiming for a pressure of 3500-3600 PSI.

In the 15 mg/kg trial, pressure in the cell reached 3500-3700 PSI in 11.5 minutes and the disc became sealed with wax and Rev Dust. To assess the extent of formation damage, the sealed discs were then flipped over and heated to 90° C. by passing hot water through the disc to simulate geothermal heat removal in a formation. Pressure did not build in the cell on reversal of the disc and all of the water passed through the disc in about 10 minutes. In this trial, PPT was 633 mL, Spurt Loss was 559.9 mL and Static Filtration Rate was 13.94 mL/min½.

Spurt Loss and Static Filtration (15 mg/kg Trial)

| Root Time | Spurt Loss Effluent Volume | Static Filtration Effluent Volume |
|---|---|---|
| (min^{1/2}) | (mL) | (mL) |
| 0 | 0 | 559.88 |
| 1 | 176.87 | 573.82 |
| 2 | 353.73 | 587.76 |
| 3 | 530.60 | 601.69 |
| 4 | 707.47 | 615.63 |
| 5 | 884.34 | 629.57 |
| 6 | 1061.20 | 643.50 |

In the 30 mg/kg trial, the disc became sealed with wax immediately and the pressure in the cell could be maintained at 3500-3700 PSI for the entire trial, indicating a good seal and a fast sealing effect. When the disc was reversed and heated to 90° C., pressure was maintained in the cell and it took about 47 minutes for all of the water to pass through the disc. In this trial, PPT was 27.8 mL, Spurt Loss was 21.4 mL and Static Filtration Rate was 1.2 mL/min½.

Spurt Loss and Static Filtration (30 mg/kg Trial)

| Root Time | Spurt Loss Effluent Volume | Static Filtration Effluent Volume |
|---|---|---|
| (min^{1/2}) | (mL) | (mL) |
| 0 | 0 | 21.41 |
| 1 | 10.16 | 22.62 |
| 2 | 20.32 | 23.82 |
| 3 | 30.48 | 25.02 |
| 4 | 40.64 | 26.22 |
| 5 | 50.8 | 27.43 |
| 6 | 60.96 | 28.63 |

The tests were re-run and the amount of wax removed from the disc after heating was measured. It was found that greater than 80% of the wax was removed from the discs in each trial. In the 15 mg/ml trial, 84.4% of the wax was removed from the disc. In the 30 mg/kg trial, 95.8% of the wax was removed from the disc. It should be noted that some of the residual mass left in the disks after the geothermal removal process is likely due to Rev Dust that was also forced into the disk during the trial and remained lodged as a damaging solid. It is well known that non-removable solids can permanently contaminate a production zone and impairing production. The higher regain or success in the 30 kg/m³ was likely due in part to the rapid seal formed with the higher concentration of wax in the sample that would have prevented further damaging solids from penetrating the core sample.

These tests demonstrate that although the wax forms a seal on the formation (which would be effective for controlling fluid losses), the additive could be removed from a formation if the geothermal temperature of the formation exceeds melt point. The geothermal removal rate would be expected to increase as the geothermal temperature in the formation further exceeds the melt point of the wax. The temperature selected for this trial was 90° C., the melt point of the waxes. The liquefied wax would be removed with the assistance of fluid flow or gas pressures from a production zone of a formation. In the field, the gradual removal of wax from the formation due to geothermal heating would occur over a period of days to weeks (i.e. 0.5 to 14 days) and could be influenced by wax selection. The test confirms that the wax provided a non-damaging, low residual additive.

### EXAMPLE 6

Simulation of Geothermal Removal of Paraffin Additive from a Production Zone

A sample fluid was prepared as follows:
Distillate 822 base oil was viscosified with 5.9 kg/m³ Bentone 150 to provide a Yield Point of 1.5 Pa and the density was increased with 15 kg/m³ of calcium carbonate to simulate drill solids. The sample was sheared at high speed for 30 minutes. The fluid was then run through a Permeability Plugging Tester simulating dynamic conditions in an underground well bore. A 5 μm, 0.75 Darcy ceramic test disc was selected for the test procedure. The test fluid 300 cc of premixed fluid and sample of paraffin waxes, were subjected to an initial operating temperature of 35° C. and 750 psi differential pressure was placed across the face of the test disk.

Trial #1 utilized the viscosifed Distillate 822 base oil as prepared above and included the addition of IGI 1260 paraffin wax; test wax samples had a melt point of 63° C.-65° C. Test #1 wax loading was as follows:
5 kg/m3 IGI 1260 in 300-500 micron beads.
5 kg/m3 IGI 1260 in 3000-4000 micron beads.
5 kg/m3 IGI 1260 in ¼ inch flakes.

Sample disk was weighed prior to test and as per the PPT procedure and then was flooded and soaked in the test fluid for 10 min to hydrate the disk. The disk was then reweighed to account for the mass of the test fluid contained in the hydrated sample disk. The fluid sample was then mixed with the test material (wax) and placed into the PPT cell and was heated to 35° C. in the closed PPT cell, then a differential pressure of 750 psi was applied across the face of the test disk for 30 min. The volume of effluent was recorded and corrected to API (American Petroleum Institute) specifications at 83.8 cc/30 min. Wax was visually confirmed by microscope plugging the test disk.

PPT Results

| | | Cumulative | Square | |
|---|---|---|---|---|
| Time | Effluent Volume | Effluent Volume | Root time | Corrected |
| (min) | (mL by interval) | (mL) | (min^{1/2}) | Volume (mL) |
| 0 | 0.0 | 0.0 | 0.00 | 0.0 |
| 1 | 24.0 | 24.0 | 1.00 | 48.0 |
| 5 | 6.5 | 30.5 | 2.24 | 61.0 |
| 7.5 | 1.9 | 32.4 | 2.74 | 64.8 |
| 10 | 1.9 | 34.3 | 3.16 | 68.6 |
| 15 | 2.5 | 36.8 | 3.87 | 73.6 |
| 20 | 2.0 | 38.8 | 4.47 | 77.6 |
| 25 | 1.7 | 40.5 | 5.00 | 81.0 |
| 30 | 1.4 | 41.9 | 5.48 | 83.8 |

The test disk was then analyzed to determine the mass of wax that was impregnated under pressure into the sample disk as contaminant or formation damage solid. The disk was then placed back into the PPT cell in reverse with the formation damaged side away from the new test fluid. Clean Distillate 822 was chosen as a sample production fluid to prevent any possible emulsions between different fluids and 300 ml was heated above the test disk to a temperature of 75° C.-80° C. to simulate a heated reservoir or production zone fluid temperature. The heated fluid was then forced into the test disk and the 300 cm³ of Distillate 822 passed through disc after 2 minutes and 30 seconds. The 75° C.-80° C. heated fluid melted the paraffin wax having a melt point of about 65° C. and passed through the disk with minimal pressure build up. The molten wax went into solution with the simulated production fluid and was not recovered with the 300 ml of clean Distillate 822, i.e. the paraffin wax remained in solution. This has potential benefit that the wax can be produced as a component of the production fluid and accretion of the production fluid can be avoided in an undesirable location, such as a production platform, in piping, or at storage or other facility.

Testing demonstrated that a large portion of the paraffin wax used to plug the disk was removable by geothermal temperatures and reservoir production pressures.

Regain Results from PPT Test:

| Dry Disc mass | 36.7718 g |
|---|---|
| Wet Disc Mass | 43.2461 g |
| Mass after PPT | 45.0291 g |
| Mass after Regain | 43.4809 g |
| Mass Material on Disc after PPT | 1.783 g |
| Mass Material Remaining after Regain | 0.2348 g |
| % Material Removed From Disc: | 86.83% |

Test results showed 86.83% of the material exposed to the disk was removed, accounting for most of the paraffin wax. The test fluid sample included a total loading of ˜20 kg/m³ of non-wax solids or solid types that once injected into the sample disk under pressure can damage or restrict a potential production zone, and these solids account for some of the residual mass in the test disk.

The above-described embodiments of the invention are intended to be examples only. Alterations, modifications and variations can be effected to the particular embodiments by those of skill in the art without departing from the scope of the invention, which is defined solely by the claims appended hereto.

1. A method of improving lubricity or rate of penetration (ROP) in a drilling operation, comprising:
circulating a drilling fluid downhole during the drilling operation, the drilling fluid comprising a drilling fluid additive for improving lubricity or ROP;
wherein the drilling fluid additive comprises solid particles comprising wax, the wax being selected from natural wax, synthetic wax and combinations thereof.

2. The method of claim 1, wherein the natural wax is a paraffin wax, a microcrystalline wax, or a semi-microcrystalline wax.

3. The method of claim 1, wherein the synthetic wax is a polyethylene wax.

4. The method of claim 1, wherein the particles comprise microparticles less than about 50 microns in size.

5. The method of claim 4, wherein the synthetic wax is a polyethylene wax.

6. The method of claim 1, wherein the particles comprise a mixture of at least first particles and second particles, the first particles and the second particles having at least one property distinct from another, the at least one property being selected from the group consisting of type of wax, particle size, melt point, hardness, shape, blocking ability, solubility, dissolution rate and combinations thereof.

7. The method of claim 6, wherein the first particles comprise refined paraffin wax and the second particles comprise microcrystalline wax, wherein the microcrystalline particles have a higher melt point, lower hardness value or both compared to the paraffin particles.

8. The method of claim 1, wherein the wax is selected such that all or a portion of the particles are substantially insoluble in hydrocarbon below the melt point of the particles.

9. The method of claim 1, wherein the wax is selected such that all or a portion of the particles are substantially insoluble in a selected base fluid, carrier fluid or drilling fluid at a temperature below the melt point of the particles.

10. The method of claim 1, wherein the wax is selected such that all or a portion of the particles will melt at a geothermal temperature in an underground formation or at a production zone in an underground formation for geothermal removal.

11. The method of claim 2, wherein the drilling fluid additive is non-toxic and biodegradable.

12. The method of claim 11, wherein the drilling fluid is fully disposable upon completion of the drilling operation.

13. The method of claim 1, wherein the drilling fluid is aqueous based.

14. The method of claim 13, wherein the drilling fluid is viscosified.

15. The method of claim 1, wherein the drilling fluid is hydrocarbon based or an invert emulsion.

16. The method of claim 1, wherein the drilling fluid additive is added to the drilling fluid before drilling, during drilling or a combination thereof.

17. The method of claim 1, wherein the drilling fluid additive is added as a spot treatment or pill volume to a desired location during the drilling operation.

18. The method of claim 1, wherein the drilling fluid additive is added to the drilling fluid at an average concentration of about 10 kg/m³ to 20 kg/m³ over the course of the drilling operation.

19. The method of claim 1, wherein the drilling fluid additive is added to the drilling fluid while drilling ahead at an average rate of about 60 kg to about 160 kg per 100 m new hole drilled during the drilling operation.

20. The method of claim 1, wherein the drilling operation is an oil and gas drilling operation or a mining operation.

21. The method of claim 20, wherein the oil and gas drilling operation is an offshore drilling operation, wherein the drilling fluid is aqueous based, and wherein the wax is non-toxic and biodegradable.
